(19) United States
(12) Patent Application Publication
(10) Pub. No.: US 2024/0297315 A1
(43) Pub. Date: Sep. 5, 2024

(54) FUEL CELL SYSTEM AND CONTROL METHOD THEREOF

(71) Applicants: HYUNDAI MOTOR COMPANY, Seoul (KR); KIA CORPORATION, Seoul (KR)

(72) Inventors: Jae Won Jung, Suwon-si (KR); Hee Mang Lee, Goyang-si (KR); Jae Kwon Jung, Hwaseong-si (KR); Sang Wook Han, Seoul (KR)

(73) Assignees: HYUNDAI MOTOR COMPANY, Seoul (KR); KIA CORPORATION, Seoul (KR)

(21) Appl. No.: 18/522,854

(22) Filed: Nov. 29, 2023

(30) Foreign Application Priority Data
Mar. 3, 2023 (KR) 10-2023-0028547

(51) Int. Cl. H01M 8/04303; H01M 8/04111; H01M 8/04223; H01M 8/0444; H01M 8/04537; H01M 8/04746

(52) U.S. Cl. CPC H01M 8/04303; H01M 8/04111; H01M 8/04231; H01M 8/04447; H01M 8/04567; H01M 8/04753; H01M 8/04776

(57) ABSTRACT

A fuel cell system includes a fuel cell stack including a cathode and an anode. The system also includes an air compressor configured to send air to the cathode of the fuel cell stack. The system also includes an air adjustment valve configured to adjust air flowing from the air compressor into the cathode. The system also includes a hydrogen flow line configured to deliver hydrogen to the anode and discharge the hydrogen that has passed through the anode. The system also includes a controller controlling at least one of a rotation speed of the air compressor or an opening ratio of the air adjustment valve, based on at least one of a voltage of a fuel battery cell or a hydrogen concentration of the anode, in a stop control mode of the fuel cell stack.

### CROSS REFERENCE TO RELATED APPLICATIONS

The present application claims priority to Korean Patent Application No. 10-2023-0028547, filed Mar. 3, 2023, the entire contents of which are incorporated herein by reference.

### TECHNICAL FIELD

The present disclosure relates to a fuel cell system and a method of controlling the fuel cell system.

### BACKGROUND

A fuel cell is a device that is supplied with hydrogen and air from the outside and generates electrical energy through an electrochemical reaction inside a fuel cell stack. The fuel cell may be used as a power source in various fields, such as a fuel cell vehicle (FCEV) or a fuel cell for power generation.

A fuel supply system depressurizes compressed hydrogen inside a hydrogen tank and supplies hydrogen to an anode of a fuel cell stack. An air supply system operates an air compressor to supply outside air to a cathode of the fuel cell stack.

When the hydrogen is supplied to the anode of the fuel cell stack and the air including oxygen is supplied to the cathode, hydrogen ions are separated at the anode through a catalytic reaction. The separated hydrogen ions are transferred to an oxidizing electrode, which is the cathode, through an electrolyte membrane. The hydrogen ions from the anode, electrons, and oxygen cause the electrochemical reaction in the oxidation electrode, and thus electrical energy is obtained. Specifically, electrochemical oxidation of hydrogen occurs in the anode, while electrochemical reaction of oxygen occurs in the cathode. At this time, electricity and heat are generated due to the transfer of the generated electrons, and steam or water is produced by a chemical reaction between hydrogen and oxygen.

An exhaust device is provided to discharge to the atmosphere hydrogen and oxygen, which are not reacted, by-products such as steam, water, and heat generated in the electrical energy generating process in the fuel cell stack, as well as gases such as steam, hydrogen and oxygen.

On the other hand, when the required output of the fuel cell stack is zero or very small, for example, when the fuel cell vehicle is being stopped, or when the fuel cell vehicle may be driven only with a battery installed in the fuel cell vehicle, or when the fuel cell vehicle may be driven only by coasting on a downhill road, the fuel cell vehicle enters a stop control mode of the fuel cell stack.

When the stop control of the fuel cell stack is continued, the voltage of the fuel cell stack may be often lower than the voltage at which platinum is reduced and eluted. Thus, the possibility of deterioration of the fuel cell stack increases.

Further, since the air compressor is maintained at a low speed in the stop control mode of the fuel cell stack, a problem may occur in an emission concentration corresponding to an emission standard when hydrogen gas having a reduced concentration by recirculation is discharged to the outside.

The description provided above as a related art of the present disclosure is just for helping understand the background of the present disclosure and should not be construed as being included in the related art known by those having ordinary skill in the art.

### SUMMARY

Embodiments of the present disclosure provide a fuel cell system and a method of controlling the fuel cell system. The fuel cell system and the method of controlling the fuel cell system can prevent the deterioration of a fuel battery cell due to a non-uniform air flow rate that may occur during the stop control of a fuel cell stack. The fuel cell system and the method of controlling the fuel cell system can prevent the deterioration of the fuel battery cell due to a reduction in hydrogen concentration in an anode, which may occur during the stop control of the fuel cell stack. The fuel cell system and the method of controlling the fuel cell system can emit hydrogen while complying with an emission standard.

In an embodiment of the present disclosure, a fuel cell system includes: a fuel cell stack including a cathode and an anode, an air compressor configured to send air to the cathode of the fuel cell stack. The fuel cell system also includes an air adjustment valve configured to adjust air flowing from the air compressor into the cathode. The fuel cell system also includes a hydrogen flow line configured to deliver hydrogen to the anode and discharge the hydrogen that has passed through the anode. The fuel cell system also includes a controller configured to control at least one of a rotation speed of the air compressor or an opening ratio of the air adjustment valve, based on at least one of a voltage of a fuel battery cell or a hydrogen concentration of the anode, in a stop control mode of the fuel cell stack.

The controller may set a standard deviation limit value of the voltage of the fuel battery cell. The controller may also lower the standard deviation limit value of the voltage of the fuel battery cell to be equal to or less than a limit value by adjusting at least one of the rotation speed of the air compressor or an opening degree of the air adjustment valve, when the standard deviation limit value of the voltage of the fuel battery cell exceeds a set limit value of the voltage of the fuel battery cell.

The standard deviation limit value of the voltage of the fuel battery cell is lowered to be equal to or less than the set limit value of the voltage of the fuel battery cell by at least one of: i) increasing the rotation speed of the air compressor to a first speed, or ii) opening the air adjustment valve to a first opening degree.

The controller may set the limit value of a hydrogen concentration of the anode. The controller may also discharge the hydrogen through a hydrogen flow line to an outside when the hydrogen concentration of the anode falls below a set limit value of the hydrogen concentration of the anode. The controller may also dilute the discharged hydrogen by adjusting at least one of the rotation speed of the air compressor or an opening degree of the air adjustment valve.

The discharged hydrogen may be diluted by at least one of increasing the rotation speed of the air compressor to a second speed or by opening the air adjustment valve to a second opening degree.

The fuel cell system may further include an air flow line configured to deliver air to the cathode. The fuel cell system may further include a hydrogen purge line branched from the hydrogen flow line, connected to the air flow line at an outlet of the cathode, and configured to transfer purged hydrogen to the air flow line. The fuel cell system may further include a hydrogen purge valve provided on the hydrogen purge line and configured to adjust the discharged hydrogen. The controller may open the hydrogen purge valve to discharge the hydrogen when at least one of the following is met: i) the rotation speed of the air compressor is a second speed, ii) the opening degree of the air adjustment valve is a second opening degree, or iii) the rotation speed of the air compressor is the second speed and the opening degree of the air adjustment valve is the second opening degree. The controller may close the hydrogen purge valve when the discharge is completed.

The controller may set a standard deviation limit value of the voltage of the fuel battery cell. The controller may set a limit value of the hydrogen concentration of the anode. The controller may do at least one of: i) increase the rotation speed of the air compressor to a second speed, ii) open the air adjustment valve to a first opening degree, or iii) increase the rotation speed of the air compressor to the second speed and open the air adjustment valve to the first opening degree when the standard deviation limit value of the voltage of the fuel battery cell exceeds a set limit value of the voltage of the fuel battery cell and when the hydrogen concentration of the anode falls below the set limit value of the hydrogen concentration of the anode.

The fuel cell system may further include an air flow line configured to deliver air to the cathode. The fuel cell system may further include a hydrogen purge line branched from a hydrogen flow line, connected to the air flow line at an outlet of the cathode, and configured to transfer the discharged hydrogen to the air flow line. The fuel cell system may further include a hydrogen purge valve provided on the hydrogen purge line and configured to adjust the discharged hydrogen. When the standard deviation limit value of the voltage of the fuel battery cell exceeds the set limit value of the voltage of the fuel battery cell and when the hydrogen concentration of the anode falls below the set limit value of the hydrogen concentration of the anode, the controller may do at least one of: i) increase the rotation speed of the air compressor to the second speed, ii) open the air adjustment valve to the first opening degree, or iii) increase the rotation speed of the air compressor to the second speed and open the air adjustment valve to the first opening degree. The controller may further open the hydrogen purge valve to discharge the hydrogen. When the discharge is completed, the controller may close the hydrogen purge valve.

The controller may maintain the operation of the air compressor for a certain period of time after closing the hydrogen purge valve so as to dilute the discharged hydrogen.

When the hydrogen has been discharged but the standard deviation limit value of the voltage of the fuel battery cell exceeds the set limit value of the voltage of the fuel battery cell, the controller may drive the air compressor until the standard deviation of the voltage of the fuel battery cell becomes equal to or less than the set limit value of the voltage of the fuel battery cell.

The controller may stop driving the air compressor and may open the air adjustment valve, when a charge amount of the fuel battery cell acquired by repeating the stop control mode of the fuel cell stack exceeds a preset reference value.

In another embodiment of the present disclosure, a method of controlling a fuel cell system is provided. The fuel cell system includes an air compressor and an air adjustment valve supplying air to a cathode of a fuel cell stack, a controller controlling the air compressor and the air adjustment valve, and a hydrogen flow line transferring hydrogen to an anode and discharging the hydrogen which has passed through the anode. In particular, the method includes causing the controller to enter a stop control mode of the fuel cell stack, and monitoring, by the controller, a voltage of the fuel battery cell or a hydrogen concentration of the anode. The method also includes controlling, by the controller, the air compressor or the air adjustment valve based on a degree of change in the voltage of the fuel battery cell or the hydrogen concentration of the anode.

In one embodiment, the monitoring of the voltage of the fuel battery cell or the hydrogen concentration of the anode includes setting, the controller, the standard deviation limit value of the voltage of the fuel battery cell. The method also includes setting, by the controller, a limit value of the hydrogen concentration of the anode, and monitoring whether the standard deviation limit value of the voltage of the fuel battery cell exceeds a set limit value of the voltage of the fuel battery cell or whether the hydrogen concentration of the anode falls below the set limit value of the hydrogen concentration of the anode.

When it is determined that the standard deviation limit value of the voltage of the fuel battery cell exceeds the set limit value of the voltage of the fuel battery cell in the monitoring of the voltage of the fuel battery cell or the hydrogen concentration of the anode, the speed of the air compressor may be increased to a first speed, the air adjustment valve may be opened to a first opening degree, or both. Thus, the standard deviation of the voltage of the fuel battery cell may be lowered to be equal to or less than the set limit value of the voltage of the fuel battery cell, in the controlling of the air compressor or the air adjustment valve.

When it is determined that the hydrogen concentration of the anode falls below the set limit value of the hydrogen concentration of the anode in the monitoring of the voltage of the fuel battery cell or the hydrogen concentration of the anode, the hydrogen may be discharged through a hydrogen flow line to an outside, and the discharged hydrogen may be diluted by at least one of: increasing a rotation speed of the air compressor to a second speed or opening the air adjustment valve to a second opening degree, in the controlling of the air compressor or the air adjustment valve.

According to the present disclosure, a fuel cell system and a method of controlling the fuel cell system can prevent the deterioration of a fuel battery cell due to a non-uniform air flow rate that may occur during the stop control of a fuel cell stack. The fuel cell system and the method of controlling the fuel cell system can also prevent the deterioration of the fuel battery cell due to a reduction in hydrogen concentration in an anode, which may occur during the stop control of the fuel cell stack. The fuel cell system and the method of controlling the fuel cell system can also emit hydrogen while complying with an emission standard.

### BRIEF DESCRIPTION OF THE DRAWINGS

FIG. 1 is a schematic view showing a fuel cell system according to an embodiment of the present disclosure;

FIG. 2 is a graph illustrating a stop control mode of a fuel cell stack;

FIG. 3 is a graph showing a deviation of a cell voltage that occurs in the stop control mode of the fuel cell stack;

FIG. 4 is a graph showing a reduction in anode hydrogen concentration that occurs in the stop control mode of the fuel cell stack;

FIG. 5 shows the flow of hydrogen and air in the fuel cell system in the stop control mode of the fuel cell stack (for controlling the anode hydrogen concentration and diluting emission hydrogen);

FIG. 6 is a graph showing the deviation of the cell voltage and a reduction in anode hydrogen concentration that occur in the stop control mode of the fuel cell stack; and

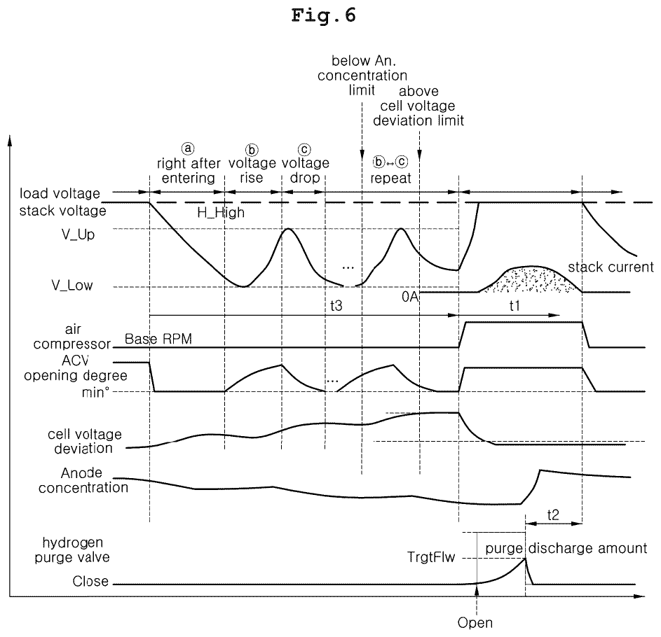

FIG. 7 is a flowchart showing a method of controlling a fuel cell system according to an embodiment of the present disclosure.

### DETAILED DESCRIPTION

Hereafter, embodiments of the present disclosure are described in detail with reference to the accompanying drawings and the same or similar components are given to the same reference numerals regardless of the numbers of figures and are not repeatedly described.

In the following description, if it is decided that the detailed description of known technologies related to the present disclosure makes the subject matter of the embodiments described herein unclear, the detailed description is omitted. Further, the accompanying drawings are provided only for easy understanding of embodiments disclosed in the specification, and the technical spirit disclosed in the specification is not limited by the accompanying drawings. All changes, equivalents, and replacements should be understood as being included in the spirit and scope of the present disclosure.

Terms including ordinal numbers, such as “first”, “second”, etc., may be used to describe various components, but the components should not be construed as being limited to the terms. The terms are used only to distinguish one component from another component.

Singular forms are intended to include plural forms unless the context clearly indicates otherwise.

It should be further understood that the terms “comprise” and “have” used in this specification specify the presence of stated features, steps, operations, components, parts, or a combination thereof. However, these terms do not preclude the presence or addition of one or more other features, numerals, steps, operations, components, parts, or a combination thereof. When a component, device, element, or the like of the present disclosure is described as having a purpose or performing an operation, function, or the like, the component, device, element, or the like should be considered herein as being “configured to” meet that purpose or to perform that operation or function. Each of the component, device, element, and the like may separately embody or be included with a processor and a memory, such as a non-transitory computer readable media, as part of the apparatus.

A fuel cell stack enters the stop control mode of the fuel cell stack in a situation where the required output of the fuel cell stack is zero or very small. Since the power generation of the fuel cell stack is unnecessary in the stop control mode, the power generation of the fuel cell stack is minimized.

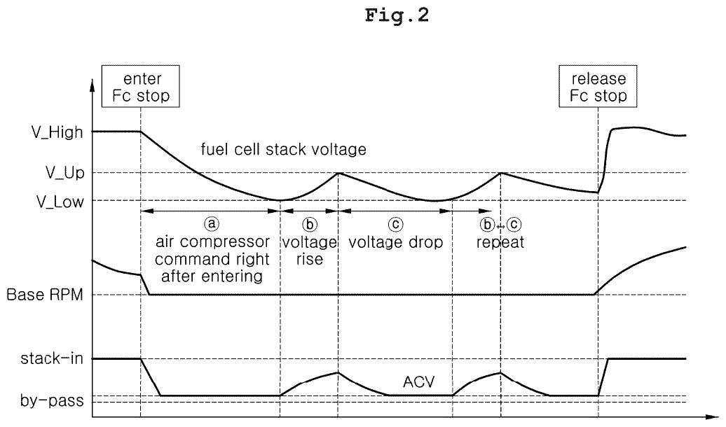

FIG. 2 is a graph illustrating the stop control mode of the fuel cell stack.

When entering the stop control mode, the voltage is repeatedly raised and lowered to avoid a situation in which it is exposed to the lower limit voltage (voltage at which platinum is reduced and eluted) of the fuel cell stack. At this time, the air compressor maintains only the minimum driving speed and adjusts the opening ratio of the air adjustment valve to perform the fine adjustment of voltage.

In the stop control mode, since the fuel cell stack controls the voltage with a small flow rate of air, the balance of the air flow rate in the cell of the fuel cell stack is broken if the stop control mode continues for a long time, thus causing a deviation in cell voltage.

Particularly, a fuel battery cell that is far from the cell voltage average negatively affects the durability of the fuel cell stack.

On the other hand, hydrogen used as fuel in the fuel cell stack is re-circulated even after passing through the anode and is introduced into the anode again to be reused. As the hydrogen is re-circulated in the anode, the concentration of the hydrogen in the anode gradually decreases. If the power generation of the fuel cell stack is performed in a state where the hydrogen concentration is low, this also adversely affects the durability of the fuel cell stack. Thus, if the hydrogen concentration of the anode is low, some hydrogen may be discharged and new hydrogen may be supplied to increase the hydrogen concentration of the anode.

However, some power generation is performed to avoid a lower voltage limit in the stop control mode, but hydrogen is not discharged from the anode in the stop control mode. Accordingly, if the stop control mode continues for a long time, power is generated in a state where the hydrogen concentration in the anode is insufficient. This adversely affects the durability of the fuel cell stack.

In order to solve the above problem, a fuel cell system according to the present disclosure includes a fuel cell stack 100 including a cathode and an anode. The fuel cell system also includes an air compressor 200 configured to send air to the cathode of the fuel cell stack 100. The fuel cell system also includes an air adjustment valve 300 configured to adjust air flowing from the air compressor 200 into the cathode. The fuel cell system also includes a hydrogen flow line 550 delivering hydrogen to the anode and discharging the hydrogen that has passed through the anode. The fuel cell system also includes a controller 400 controlling at least one of a rotation speed of the air compressor 200 or an opening ratio of the air adjustment valve 300, on the basis of at least one of a voltage of a fuel battery cell or a hydrogen concentration of the anode, in a stop control mode of the fuel cell stack 100.

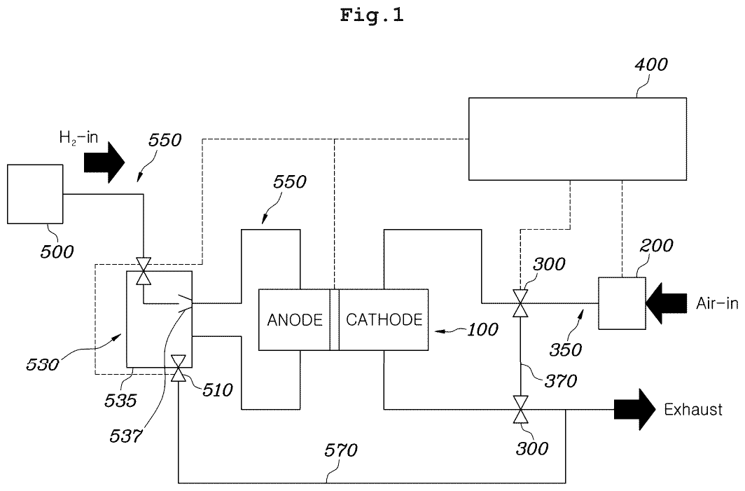

FIG. 1 is a schematic view showing a fuel cell system according to an embodiment of the present disclosure.

The air compressor 200 of the fuel cell system is provided on an air flow line 350 to pressurize outside air and supply the outside air to the cathode. The air adjustment valve 300 is provided on the air flow line 350 at each of an inlet and an outlet of the cathode to adjust the flow rate of the air introduced into the cathode.

By adjusting the opening degree of the air adjustment valve 300, a ratio between the flow rate of air flowing into the cathode and the flow rate of air that bypasses the cathode and is discharged to the outside without flowing into the cathode may be determined. In order to bypass the cathode, there is a bypass line 370 branched off from the air flow line 350 at the cathode inlet and connected to the air flow line 350 at the cathode outlet.

On the other hand, a hydrogen supply tank 500 that supplies hydrogen to the anode through a hydrogen flow line 550 is provided on the anode side of the fuel cell stack 100. A hydrogen re-circulator 530 is configured to re-circulate the hydrogen that has passed through the anode back to the anode.

The hydrogen re-circulator includes a hydrogen reservoir 535 for storing hydrogen that has passed through the anode and includes an ejector 537 for supplying hydrogen present in the hydrogen reservoir 535 back to the anode.

Although the ejector type is shown in an embodiment of the present disclosure, it is possible to use a method in which a separate blower is provided in the hydrogen flow line 550 to pressurize re-circulated hydrogen and supply the re-circulated hydrogen to the anode.

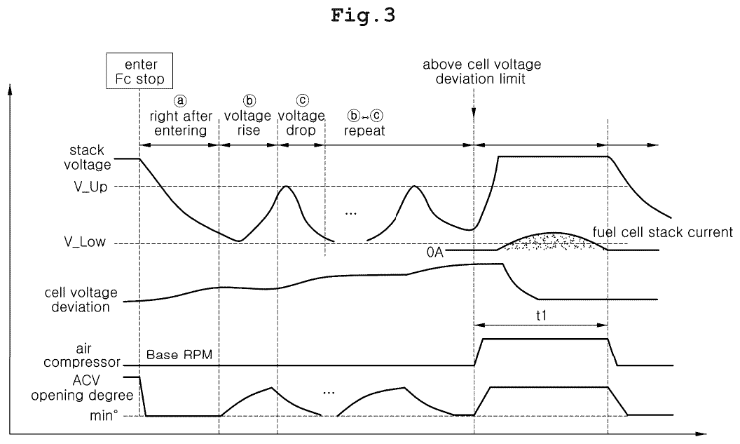

FIG. 3 is a graph showing a deviation of a cell voltage that occurs in the stop control mode of the fuel cell stack. Referring to FIG. 3, it can be seen that the deviation of the cell voltage increases when the stop control mode is entered and the voltage of the fuel cell stack is repeatedly increased and reduced. When the cell voltage deviation increases to a certain level, the controller 400 drives the air compressor 200 and opens the air adjustment valve 300 to reduce the cell voltage deviation.

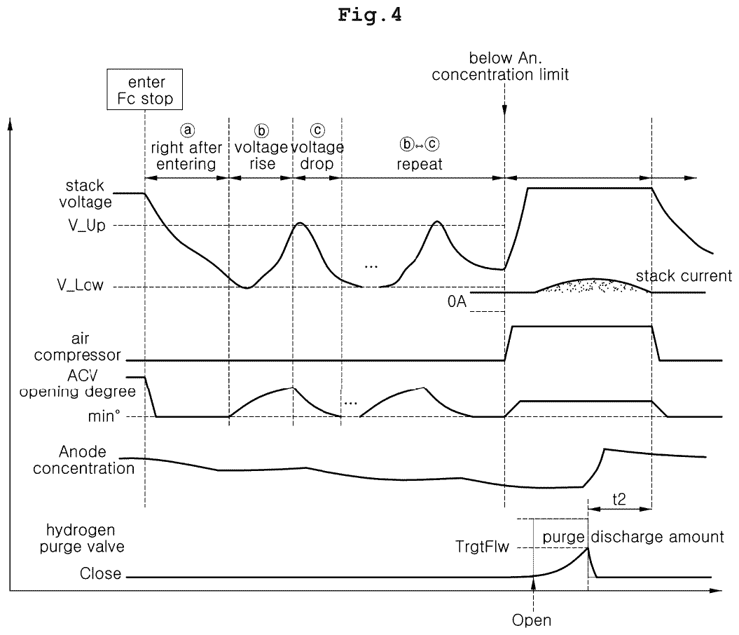

FIG. 4 is a graph showing a reduction in anode hydrogen concentration that occurs in the stop control mode of the fuel cell stack. Referring to FIG. 4, it can be seen that the hydrogen concentration of the anode gradually decreases when the stop control mode is entered and the voltage of the fuel cell stack is repeatedly increased and reduced. When the hydrogen concentration of the anode decreases to a certain level, the re-circulated hydrogen is discharged through the hydrogen flow line 550 to the outside and the hydrogen is supplied from the hydrogen supply tank 500 to increase the hydrogen concentration of the anode.

However, the concentration of hydrogen discharged to the outside is regulated by the law. Therefore, it is necessary to dilute the discharged hydrogen to a legal emission concentration. Accordingly, the controller 400 drives the air compressor 200 and opens the air adjustment valve 300 to dilute the discharged hydrogen.

Accordingly, even when the stop control mode of the fuel cell stack 100 continues for a long time, the voltage deviation of the fuel battery cell is improved and the anode hydrogen concentration is prevented from decreasing, thereby increasing the durability of the fuel cell stack 100.

Meanwhile, each component may be specifically controlled as follows.

First, control for lowering the standard deviation of the voltage of the fuel battery cell may be made as follows.

The controller 400 may set the standard deviation limit value of the voltage of the fuel battery cell, and may adjust the speed of the air compressor 200 or the opening ratio of the air adjustment valve 300 when the standard deviation of the voltage of the fuel battery cell exceeds a set limit value, thus decreasing the standard deviation of the voltage of the fuel battery cell to the set limit value or less.

For example, when the limit value of the voltage standard deviation is set to 0.3V and the standard deviation of the voltage exceeds 0.3V as a result of the controller 400 monitoring the fuel battery cell, the controller 400 may adjust the standard deviation of the voltage of the fuel battery cell to 0.3V or less by increasing the speed of the air compressor 200 and the opening degree of the air adjustment valve 300.

To be more specific, the controller 400 may perform at least one of: increasing the speed of the air compressor 200 to the first speed or opening the air adjustment valve 300 to the first opening degree, thus decreasing the standard deviation of the voltage of the fuel battery cell to a set limit value or less.

Referring to FIG. 3, the first speed and the first opening degree may be maintained for a time t1 to reduce the standard deviation of the voltage of the fuel battery cell to the set limit value or less.

Here, expressions, such as the first speed or the first opening degree, mean any values. In other words, since the speed of the air compressor and the opening degree of the air adjustment valve are determined according to various variables, such as the specifications of the used air compressor and the used air adjustment valve, a clear value is not given.

Meanwhile, control for increasing the hydrogen concentration of the anode may be made as follows.

The controller 400 may set the limit value of the hydrogen concentration of the anode and may discharge the hydrogen through the hydrogen flow line 550 to the outside when the hydrogen concentration of the anode falls below to the set limit value. The controller 400 may adjust the speed of the air compressor 200 or the opening degree of the air adjustment valve 300 to dilute the discharged hydrogen.

In other words, when the anode hydrogen concentration is reduced to be less than the limit value, the hydrogen may be discharged through the hydrogen flow line 550 to the outside, so low concentration hydrogen is discarded, and hydrogen is supplied from the hydrogen supply tank 500 to increase the anode hydrogen concentration to the limit value or more.

However, in order for hydrogen to be discharged to the outside, it should satisfy the concentration specified by the law or less. To this end, the controller 400 may dilute the discharged hydrogen by increasing the speed of the air compressor 200 to the second speed, opening the air adjustment valve 300 to the second opening degree, or both so as to increase the flow rate of air.

As for the speed of the air compressor 200 and the opening degree of the air adjustment valve 300, the second speed may be set to a value greater than the first speed. The second opening degree may be set to a value smaller than the first opening degree.

When the recovery of the anode hydrogen concentration and the dilution of the discharged hydrogen are required, the amount of the air introduced into the fuel cell stack 100 is less than an amount required for decreasing the standard deviation of the voltage of the fuel battery cell. Rather, since a large flow rate of bypassed air is required for diluting the discharged hydrogen, the speed of the air compressor 200 is high but the opening degree of the air adjustment valve 300 should be small.

On the other hand, the fuel cell system according to the present disclosure may further include an air flow line 350 delivering air to the cathode. The fuel cell system may further include a hydrogen purge line 570 branched from the hydrogen flow line 550, connected to the air flow line 350 at an outlet of the cathode, and transferring the purged hydrogen to the air flow line 350. The fuel cell system may further include a hydrogen purge valve 510 provided on the hydrogen purge line 570 to adjust the discharged hydrogen. The controller 400 may open the hydrogen purge valve 510 to discharge the hydrogen when the speed of the air compressor 200 is the second speed or the opening degree of the air adjustment valve 300 is the second opening degree. The controller 400 may close the hydrogen purge valve 510 when the discharge is completed.

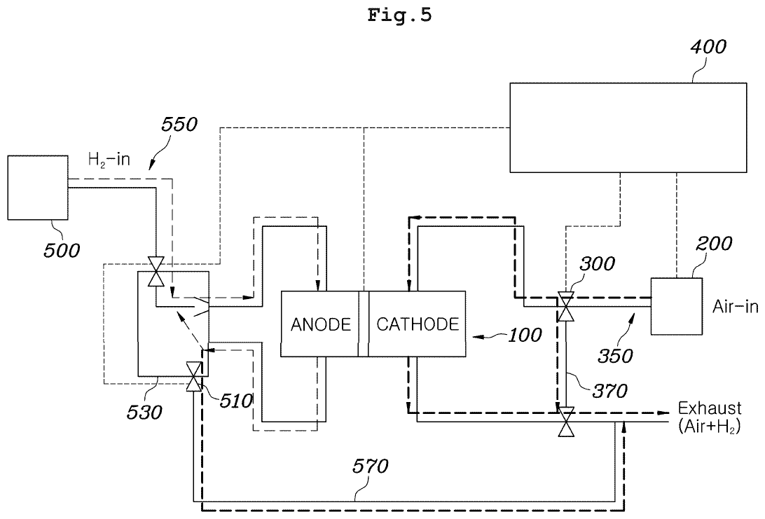

Specifically, referring to FIGS. 4 and 5, when the hydrogen concentration of the anode is lower than the set limit value, the hydrogen purge valve 510 may be opened to discharge the hydrogen to the outside. However, when the speed of the air compressor 200 satisfies the second speed and when the opening degree of the air adjustment valve 300 satisfies the second opening degree, the hydrogen purge valve 510 is desirably opened.

In other words, it is desirable that the hydrogen purge valve 510 is open after sufficiently securing the flow rate of air discharged to the outside by bypassing the cathode.

When the hydrogen discharge amount satisfies a target discharge amount, the hydrogen purge valve 510 is closed (the target discharge amount “Trgtflw” corresponds to an estimated value derived by the air flow rate).

After the hydrogen purge valve 510 is closed, the speed of the air compressor 200 and the opening degree of the air adjustment valve 300 are maintained for a certain time t2 so that hydrogen can be well diluted.

On the other hand, when the stop control mode of the fuel cell stack 100 continues for a long time, a case where the standard deviation of the voltage of the fuel battery cell exceeds the limit value and a case where the hydrogen concentration of the anode falls below to the limit value may occur simultaneously.

To solve this problem, the controller 400 may perform at least one of: increasing the speed of the air compressor 200 to the second speed or opening the air adjustment valve 300 to the first opening degree.

In other words, in order to simultaneously solve both cases, the speed of the air compressor 200 is increased to the second speed so as to secure a sufficient flow rate to dilute hydrogen, and the opening degree of the air adjustment valve 300 is set to the first opening degree so as to decrease the standard deviation of the voltage of the fuel battery cell to below the limit value.

Similarly, when both cases occur simultaneously, the hydrogen purge valve 510 is opened to discharge hydrogen if the speed of the air compressor 200 satisfies the second speed, and the hydrogen purge valve 510 is closed if a hydrogen discharge amount satisfies a target discharge amount. Further, the controller 400 may dilute the discharged hydrogen by maintaining the operation of the air compressor 200 for a certain period of time after closing the hydrogen purge valve 510.

However, when the hydrogen discharge is completed but the standard deviation of the voltage of the fuel battery cell still exceeds the set limit value, the controller 400 may drive the air compressor 200 until the standard deviation of the voltage of the fuel battery cell becomes equal to or less than the set limit value. Thus, the standard deviation of the voltage of the fuel battery cell is reduced to the limit value or less.

On the other hand, the battery may be charged by an output generated by repeating the stop control mode of the fuel cell stack 100. The battery may be connected to a high-voltage bus terminal in parallel with the fuel cell stack to drive the balance of plant (BoP) of the fuel cell system or various types of electronic equipment.

In general, since a charge completion capacity is set at 80% to 90% of a total battery capacity for durability of the battery, the controller 400 may stop driving the air compressor and may open the air adjustment valve 300 when the charge amount of the battery obtained by repeating the stop control mode of the fuel cell stack 100 exceeds a preset reference value.

Specifically, in order to avoid overcharging the battery, the supply of air is stopped and the voltage of the fuel cell stack 100 is maintained at 0V. However, the air adjustment valve 300 is maintained in an open state, which prevents the output from being delayed when the fuel cell stack 100 is started.

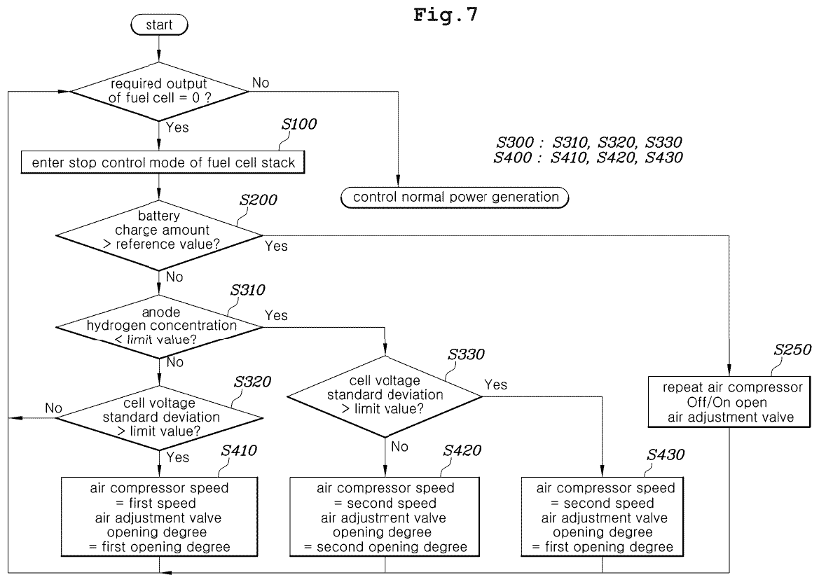

FIG. 7 is a flowchart showing a method of controlling a fuel cell system according to an embodiment of the present disclosure.

The method of controlling the fuel cell system according to the present disclosure includes a step S100 of entering a stop control mode of the fuel cell stack 100. The method also includes a step S300 of monitoring, by the controller 400, the voltage of the fuel battery cell or the hydrogen concentration of the anode. The method also includes a step S400 of controlling, by the controller 400, the air compressor 200 or the air adjustment valve 300 depending on the degree of change in the voltage or the fuel battery cell or the hydrogen concentration of the anode.

In the step S300 of monitoring the voltage of the fuel battery cell or the hydrogen concentration of the anode, the controller 400 may set the standard deviation limit value of the voltage of the fuel battery cell and may set the limit value of the hydrogen concentration of the anode. The controller 400 may monitor whether the hydrogen concentration of the anode falls below the set limit value (S310) and may monitor whether the standard deviation of the voltage of the fuel battery cell exceeds the set limit value (S320 and S330). The step 400 of controlling the air compressor 200 or the air adjustment valve 300 may include the step of S410, the step of S420, and the step of S430.

When it is determined that the hydrogen concentration of the anode does not fall below the set limit value (No in S310) and the standard deviation of the voltage of the fuel battery cell exceeds the set limit value (Yes in S320), the speed of the air compressor 200 may increase to a first speed and/or the air adjustment valve 300 may be opened to a first opening degree in step S410. Thus, the standard deviation of the voltage of the fuel battery cell may be lowered to the set limit value or less.

When it is determined that the hydrogen concentration of the anode falls below the set limit value (Yes in S310) and the hydrogen concentration of the anode does not exceed the set limit value (No in S330), the hydrogen may be discharged through the hydrogen flow line 550 to the outside, and the discharged hydrogen may be diluted by increasing the speed of the air compressor 200 to the second speed and/or opening the air adjustment valve 300 to the second opening degree in S420.

When it is determined that the standard deviation of the voltage of the fuel battery cell exceeds the set limit value (Yes in S330) and the hydrogen concentration of the anode falls below the set limit value (Yes in S310), the hydrogen may be discharged through the hydrogen flow line 550 to the outside, and the discharged hydrogen may be diluted by increasing the speed of the air compressor 200 to the second speed and/or opening the air adjustment valve 300 to the first opening degree in S430.

On the other hand, the method of controlling the fuel cell system may perform a step S200 of determining whether the charge amount of the battery obtained by repeating the stop control mode of the fuel cell stack 100 exceeds a preset reference value before the step S300 of monitoring the voltage of the fuel battery cell or the hydrogen concentration of the anode. When a charge amount of the battery obtained by repeating the stop control mode of the fuel cell stack does not exceed a preset reference value (No in S200), the controller 400 may perform the step S300, i.e., S310, S320, and S330, as described above.

When the charge amount of the battery obtained by repeating the stop control mode of the fuel cell stack exceeds the preset reference value (Yes in S200), the controller 400 may stop driving the air compressor 200, and the air adjustment valve 300 may be opened in S250.

Specifically, in order to avoid overcharging the battery, the supply of air is stopped, and the voltage of the fuel cell stack 100 is maintained at 0V. However, the air adjustment valve 300 is maintained in an open state, and thus the output is inhibited or prevented from being delayed when the fuel cell stack 100 is started.

Although the present disclosure was provided above in relation to specific embodiments shown in the drawings, it is apparent to those having ordinary skill in the art that the present disclosure may be changed and modified in various ways without departing from the scope of the present disclosure. The scope of the present disclosure is described in the following claims.

1. A fuel cell system comprising:
a fuel cell stack including a cathode and an anode;
an air compressor configured to send air to the cathode of the fuel cell stack;
an air adjustment valve configured to adjust air flowing from the air compressor into the cathode;
a hydrogen flow line configured to deliver hydrogen to the anode and discharge the hydrogen that has passed through the anode; and
a controller configured to control at least one of a rotation speed of the air compressor or an opening ratio of the air adjustment valve, based on at least one of a voltage of a fuel battery cell or a hydrogen concentration of the anode, in a stop control mode of the fuel cell stack.

2. The fuel cell system of claim 1, wherein the controller is further configured to:
set a standard deviation limit value of the voltage of the fuel battery cell and
lower the standard deviation limit value of the voltage of the fuel battery cell to be equal to or less than a limit value of the voltage of the fuel battery cell by adjusting at least one of the rotation speed of the air compressor or an opening degree of the air adjustment valve, when the standard deviation limit value of the voltage of the fuel battery cell exceeds a set limit value of the voltage of the fuel battery cell.

3. The fuel cell system of claim 2, wherein the standard deviation limit value of the voltage of the fuel battery cell is lowered to be equal to or less than the set limit value of the voltage of the fuel battery cell by at least one of: i) increasing the rotation speed of the air compressor to a first speed, or ii) opening the air adjustment valve to a first opening degree.

4. The fuel cell system of claim 1, wherein the controller is further configured to:
set a limit value of the hydrogen concentration of the anode,
discharge the hydrogen through a hydrogen flow line to an outside when the hydrogen concentration of the anode falls below a set limit value of the hydrogen concentration of the anode, and
dilute the discharged hydrogen by adjusting at least one of the rotation speed of the air compressor or an opening degree of the air adjustment valve.

5. The fuel cell system of claim 4, wherein the discharged hydrogen is diluted by at least one of: increasing the rotation speed of the air compressor to a second speed or by opening the air adjustment valve to a second opening degree.

6. The fuel cell system of claim 1, further comprising:
an air flow line configured to deliver air to the cathode;
a hydrogen purge line branched from a hydrogen flow line, connected to the air flow line at an outlet of the cathode, and configured to transfer purged hydrogen to the air flow line; and
a hydrogen purge valve provided on the hydrogen purge line and configured to adjust the discharged hydrogen,
wherein the controller opens the hydrogen purge valve to discharge the hydrogen when at least one of the following is met: i) the rotation speed of the air compressor is a second speed, ii) an opening degree of the air adjustment valve is a second opening degree, or iii) the rotation speed of the air compressor is the second speed and the opening degree of the air adjustment valve is the second opening degree, and
wherein the controller is configured to close the hydrogen purge valve when the discharge is completed.

7. The fuel cell system of claim 1, wherein the controller is further configured to:
set a standard deviation limit value of the voltage of a fuel battery cell, and
set a limit value of the hydrogen concentration of the anode, and
wherein the controller is further configured to do at least one of: i) increase the rotation speed of the air compressor to a second speed, ii) open the air adjustment valve to a first opening degree, or iii) increase the rotation speed of the air compressor to the second speed and open the air adjustment valve to the first opening degree, when the standard deviation limit value of the voltage of the fuel battery cell exceeds a set limit value of the voltage of the fuel battery cell and when the hydrogen concentration of the anode falls below the set limit value of the hydrogen concentration of the anode.

8. The fuel cell system of claim 7, further comprising:
an air flow line configured to deliver air to the cathode;
a hydrogen purge line branched from a hydrogen flow line, connected to the air flow line at an outlet of the cathode, and configured to transfer the discharged hydrogen to the air flow line; and
a hydrogen purge valve provided on the hydrogen purge line and configured to adjust the discharged hydrogen,
wherein, when the standard deviation limit value of the voltage of the fuel battery cell exceeds the set limit value of the voltage of the fuel battery cell and when the hydrogen concentration of the anode falls below the set limit value of the hydrogen concentration of the anode, the controller is configured to do at least one of: i) increase the rotation speed of the air compressor to the second speed, ii) open the air adjustment valve to the first opening degree, or iii) increase the rotation speed of the air compressor to the second speed and open the air adjustment valve to the first opening degree, and the controller is further configured to open the hydrogen purge valve to discharge the hydrogen, and,
wherein when the discharge is completed, the controller is configured to close the hydrogen purge valve.

9. The fuel cell system of claim 8, wherein the controller is further configured to maintain an operation of the air compressor for a certain period of time after closing the hydrogen purge valve so as to dilute the discharged hydrogen.

10. The fuel cell system of claim 7, wherein, when the hydrogen has been discharged but the standard deviation limit value of the voltage of the fuel battery cell exceeds the set limit value of the voltage of the fuel battery cell, the controller is configured to drive the air compressor until the standard deviation limit value of the voltage of the fuel battery cell becomes equal to or less than the set limit value of the voltage of the fuel battery cell.

11. The fuel cell system of claim 1, wherein the controller is configured to stop driving the air compressor and open the air adjustment valve, when a charge amount of the fuel battery cell acquired by repeating the stop control mode of the fuel cell stack exceeds a preset reference value.

12. A method of controlling a fuel cell system comprising an air compressor and an air adjustment valve configured to supply air to a cathode of a fuel cell stack, a controller configured to control the air compressor and the air adjustment valve, and a hydrogen flow line configured to transfer hydrogen to an anode and discharge the hydrogen, which has passed through the anode, the method comprising:
performing, by the controller, a stop control mode of the fuel cell stack;
monitoring, by the controller, a voltage of a fuel battery cell or a hydrogen concentration of the anode; and
controlling, by the controller, at least one of the air compressor or the air adjustment valve based on a degree of change in the voltage of the fuel battery cell or the hydrogen concentration of the anode.

13. The method of claim 12, wherein monitoring the voltage of the fuel battery cell or the hydrogen concentration of the anode includes:
setting, by the controller, a standard deviation limit value of the voltage of the fuel battery cell;
setting, by the controller, a limit value of the hydrogen concentration of the anode; and
monitoring, by the controller, whether the standard deviation limit value of the voltage of the fuel battery cell exceeds a set limit value of the voltage of the fuel battery cell or whether the hydrogen concentration of the anode falls below the set limit value of the hydrogen concentration of the anode.

14. The method of claim 13, further comprising: in response to determining that the standard deviation limit value of the voltage of the fuel battery cell exceeds the set limit value of the voltage of the fuel battery cell, increasing a rotation speed of the air compressor to a first speed or opening the air adjustment valve to a first opening degree to lower the standard deviation limit value of the voltage of the fuel battery cell to be equal to or less than the set limit value of the voltage of the fuel battery cell.

15. The method of claim 13, further comprising: in response to determining that the hydrogen concentration of the anode falls below the set limit value of the hydrogen concentration of the anode, discharging the hydrogen through a hydrogen flow line to an outside, and diluting the discharged hydrogen by at least one of: increasing a rotation speed of the air compressor to a second speed or opening the air adjustment valve to a second opening degree.
